(19) United States
(12) Patent Application Publication
(10) Pub. No.: US 2024/0416332 A1
(43) Pub. Date: Dec. 19, 2024

(54) POSITIVELY CHARGED QUATERNARY AMMONIUM SALT POLYMER CATALYST AND PREPARATION METHOD AND APPLICATION THEREOF

(71) Applicant: University of Science and Technology of China, Hefei (CN)

(72) Inventors: Yi Yang, Hefei (CN); Fengxian Xu, Hefei (CN); Yunfei Xu, Hefei (CN); Xinglin Lu, Hefei (CN)

(73) Assignee: University of Science and Technology of China, Hefei (CN)

(21) Appl. No.: 18/429,338

(22) Filed: Jan. 31, 2024

(30) Foreign Application Priority Data
Jun. 19, 2023 (CN) 202310738479.8

(51) Int. Cl. B01J 31/06; B01J 37/04; B01J 37/30; C02F 1/72; C02F 101/30

(52) U.S. Cl. CPC B01J 31/06; B01J 37/04; B01J 37/30; C02F 1/722; C02F 1/725; B01J 2231/70; C02F 2101/30

(57) ABSTRACT

The present disclosure belongs to the field of water treatment, and specifically relates to a positively charged quaternary ammonium salt polymer catalyst and its preparation method and an application thereof. The catalyst provided by the present disclosure is prepared from a positively charged quaternary ammonium salt precursor through polymerization and anion exchange, wherein the positively charged quaternary ammonium salt precursor is the reaction product of an acrylate and a haloalkane; the acrylate is selected from the group consisting of dimethylaminoethyl acrylate, dimethylaminoethyl methacrylate, ethyl 3-(dimethylamino)acrylate and a mixture thereof; the haloalkane is selected from the group consisting of bromoundecane, bromododecane, bromotetradecane, bromohexadecane, bromoeicosane, chlorododecane, chlorotetradecane, chlorohexadecane, and a mixture thereof. The catalyst provided by the present disclosure has good stability and antibacterial property, can efficiently and selectively catalyze peroxide to degrade organic pollutants, which has important practical significance for removing wastewater rich in organic pollutants, and it has a wide range of application prospects in water pollution control and water environment restoration.

### CROSS-REFERENCE OF RELATED APPLICATION

The present application claims the priority of Chinese Patent Application No. 202310738479.8, filed with the China National Intellectual Property Administration on Jun. 19, 2023, and titled with “POSITIVELY CHARGED QUATERNARY AMMONIUM SALT POLYMER CATALYST AND PREPARATION METHOD AND APPLICATION THEREOF”, which is hereby incorporated by reference in its entirety.

### FIELD

The present disclosure relates to the field of water treatment, and specifically relates to a positively charged quaternary ammonium salt polymer catalyst and a preparation method and an application thereof.

### BACKGROUND

Water is an essential material resource for organisms, and the global water shortage and water pollution problems have been in an urgent status needed to be solved. Among them, the increase in the human population has led to a large number of organic pollutants in domestic sewage discharged from daily life, and second, chemical engineering enterprises, pharmaceutical industries and textile industries have also produced a large number of industrial wastewater containing complex organic pollutants with the industrial development, and such pollutants are highly toxic and difficult to remove. In order to solve the problem of sewage purification, research scholars have developed a series of remediation techniques to remove organic pollutants from water, such as physical adsorption, sedimentation, coagulation, and the like. However, such traditional means are difficult to fully mineralize such pollutants, and studies have shown that advanced oxidation processes based on peroxymonosulfate (PMS), persulfacte (PDS), peroxyacetic acid (PAA), hydrogen peroxide (H₂O₂), and other organic peroxides can effectively remove organic pollutants from water. Peroxides can be activated by free radical and non-free radical pathways to produce oxidatively active species, such as sulfate free radical, hydroxyl free radical, singlet oxygen, and the like.

The common methods of homogeneous activations of this kind of oxidant include ultraviolet activation, that is, UV-induced breaking of the peroxide bond in the oxidant to produce free radicals; thermal activation, that is, the peroxide bond in the oxidant is broken by heating to produce free radicals; transition metal ion activation, that is, the use of Co²⁺, Mn²⁺, Fe²⁺, etc., induces the activation of peroxides to produce free radicals. Homogeneous activation has the advantage of high selectivity and high activity, but the disadvantage is that it is difficult to separate from the reaction system and it is impossible to carry out cyclic experiments, which leads to an increase in the cost of degrading organic pollutants. In addition to homogeneous catalysis, heterogeneous activation has become a research hot in the environmental field in recent years because it can realize efficient degradation and treatment of organic matter. Heterogeneous activation is usually a mixed reaction of solid catalysts in a liquid state, and such solid catalysts are more easily separated from the system and reused repeatedly.

Traditional heterogeneous solid catalysts, such as carbon-based materials, metal oxides and metal complexes, etc., often need to be synthesized by complex means, such as physical/chemical vapor deposition method, high-temperature calcination, etc., which makes the catalysts have problems of high production cost and poor using effect in practical industrial applications.

### SUMMARY

In view of this, the purpose of the present disclosure is to provide a positively charged quaternary ammonium salt polymer catalyst, and a preparation method and an application thereof, the catalyst provided by the present disclosure can be obtained by simple chemical synthesis of cheap raw materials, and it can catalyze and activate peroxide to generate ketone oxide and singlet oxygen in a short period of time to complete the efficient removal of organic pollutants in water.

The present disclosure provides a positively charged quaternary ammonium salt polymer catalyst, which is prepared from a positively charged quaternary ammonium salt precursor through polymerization and anion exchange, wherein the positively charged quaternary ammonium salt precursor is the reaction product of an acrylate and a haloalkane;
wherein the acrylate is selected from the group consisting of dimethylaminoethyl acrylate, dimethylaminoethyl methacrylate, ethyl 3-(dimethylamino)acrylate and a mixture thereof; and the haloalkane is selected from the group consisting of bromoundecane, bromododecane, bromotetradecane, bromohexadecane, bromoeicosane, chlorododecane, chlorotetradecane, chlorohexadecane, and a mixture thereof.

Preferably, the acrylate is dimethylaminoethyl acrylate and/or dimethylaminoethyl methacrylate; the haloalkane is selected from the group consisting of bromoundecane, bromododecane, bromotetradecane, bromohexadecane, and a mixture thereof.

The present disclosure provides a method of preparing the positively charged quaternary ammonium salt polymer catalyst as described in the above embodiment, comprising steps of:
a) reacting the acrylate with the haloalkane in a solvent to obtain the positively charged quaternary ammonium salt precursor;
b) performing polymerization of the positively charged quaternary ammonium salt precursor to obtain a polymer;
c) performing ion exchange of anions in the polymer to obtain the positively charged quaternary ammonium salt polymer catalyst.

Preferably, in step a), the reaction is performed at a temperature of 10-200° C.; and the time of the reaction is 1-48 h.

Preferably, step b) is specifically as following:
b1) mixing the positively charged quaternary ammonium salt precursor, water, an initiator and a cross-linking agent, and performing cross-linking polymerization under ultraviolet irradiation to obtain the polymer, wherein the initiator is a photoinitiator; or
b2) mixing the positively charged quaternary ammonium salt precursor, water, an initiator and a cross-linking agent in ethanol, heating to volatilize ethanol and performing cross-linking polymerization of the mixture to obtain the polymer, wherein the initiator is a thermal initiator; or
b3) mixing the positively charged quaternary ammonium salt precursor, an initiator and a catalyst in a solvent, heating for addition polymerization, and then dropping the obtained polymerization product solution into a low-polarity solvent to obtain the polymer, wherein the initiator is an chain initiator for addition polymerization, and the catalyst is an organic alkali metal catalyst.

Preferably, in step b1), the mass ratio of the positively charged quaternary ammonium salt precursor to water is (0.1-20):1; the mass ratio of the initiator to the cross-linking agent is 1:(0.5-2); the total mass of the initiator and the cross-linking agent accounts for 1-10 wt % of the total mass of the positively charged quaternary ammonium salt precursor and water; the time of cross-linking polymerization is 0.5-5 min;
in step b2), the mass ratio of the positively charged quaternary ammonium salt precursor to water is (0.1-20):1; the mass ratio of the initiator to the cross-linking agent is 1:(0.5-2); the total mass of the initiator and the cross-linking agent accounts for 1-10 wt % of the total mass of the positively charged quaternary ammonium salt precursor and water; the heating is performed at a temperature of 40-90° C.; and the time of cross-linking polymerization is 5-30 min;

in step b3), the mass ratio of the positively charged quaternary ammonium salt precursor, initiator and catalyst is 1:(0.05-0.1):(0.005-0.02); the heating temperature is 30-60° C.; the time of addition polymerization is 5-60 min.

The present disclosure provides a method for treating organic pollutants in water, comprising steps of:
activating a peroxide by using a positively charged quaternary ammonium salt polymer catalyst to degrade organic pollutants in water;
wherein the positively charged quaternary ammonium salt polymer catalyst is the positively charged quaternary ammonium salt polymer catalyst as described in the above embodiments or the positively charged quaternary ammonium salt polymer catalyst prepared by the preparation method described in the above embodiments.

Preferably, the treatment process specifically comprises:
A) adding the positively charged quaternary ammonium salt polymer catalyst and peroxide into water, wherein the peroxide degrades organic pollutants in the water after being activated by the positively charged quaternary ammonium salt polymer catalyst; or
B) firstly adsorbing organic pollutants in water by using the positively charged quaternary ammonium salt polymer catalyst, and then degrading adsorbed organic pollutants by using the peroxide after being activated by the positively charged quaternary ammonium salt polymer catalyst.

Preferably, the positively charged quaternary ammonium salt polymer catalyst and the peroxide are used in the ratio of (0.05-20) g:(0.1-200) mmol.

Preferably, the water has a pH value of 4-12.

Compared with the prior art, the present disclosure provides a positively charged quaternary ammonium salt polymer catalyst and a preparation method and an application thereof. The catalyst provided by the present disclosure is prepared from the positively charged quaternary ammonium salt precursor through polymerization and anion exchange, wherein the positively charged quaternary ammonium salt precursor is the reaction product of an acrylate and a haloalkane; the acrylate is selected from the group consisting of dimethylaminoethyl acrylate, dimethylaminoethyl methacrylate, ethyl 3-(dimethylamino)acrylate and a mixture thereof; the haloalkane is selected from the group consisting of bromoundecane, bromododecane, bromotetradecane, bromohexadecane, bromoeicosane, chlorododecane, chlorotetradecane, chlorohexadecane, and a mixture thereof. The catalyst can catalyze and activate peroxide to mineralize and degrade organic pollutants, the specific process is as follows: the catalyst reacts with a peroxide to generate a ketone oxide intermediate, and the intermediate further reacts with a peroxide to generate singlet oxygen active species, thereby mineralizing organic pollutants. The catalyst provided by the present disclosure has a carbonyl functional group and a positively charged quaternary ammonium functional group at the same time, and the introduction of the quaternary ammonium functional group changes the electron cloud density of the activation site of the carbonyl functional group, which can enhance the oxidation ability of the ketone peroxide intermediate, meanwhile, the positively charged quaternary ammonium functional group can also enhance the adsorption of pollutants in the water through the electrostatic adsorption force to accelerate the rate of pollutant degradation. The catalyst provided by the present disclosure has good stability and antibacterial property, can efficiently and selectively catalyze peroxide to degrade organic pollutants, and has important practical significance for removing wastewater rich in organic pollutants, which is from agriculture, printing and dyeing industry, petrochemical industry, and the like; moreover, due to the simple production method and low production cost of the catalyst of the present disclosure, large-scale industrial production and utilization can be realized, and it has a wide application prospects in water pollution control and water environment restoration.

### BRIEF DESCRIPTION OF DRAWINGS

In order to clearly describe the examples of the present disclosure or the embodiments in the prior art, the drawings referred to for describing the examples or the prior art will be briefly introduced hereinafter. Apparently, the drawings in the following description are only some examples of the present disclosure, and for those skilled in the art, other drawings may be obtained based on the provided drawings without any inventive labor.

FIG. 1 shows a nuclear magnetic resonance hydrogen spectrum of the positively charged quaternary ammonium salt precursor provided by the examples of the present disclosure;

FIG. 2 shows a total reflectance-fourier transform infrared spectrum of the positively charged quaternary ammonium salt polymer catalyst before and after completion of ion exchange provided by the examples of the present disclosure;

FIG. 3 shows an X ray photoelectron spectroscopy of polymer catalyst before and after ion exchange provided by the examples of the present disclosure;

FIG. 4 shows a scanning electron micrograph of positively charged quaternary ammonium salt polymer catalyst provided by the examples of the present disclosure;

FIG. 5 shows a plot of the degradation rate of pollutants at different pHs provided by the embodiment of the present disclosure;

FIG. 6 shows an electron paramagnetic resonance spectrum of reactive species generated by the reaction between PMS and the positively charged quaternary ammonium salt polymer catalyst provided by the examples of the present disclosure.

### DETAILED DESCRIPTION

The technical solutions in the examples of the present disclosure will be described clearly and completely below, it is apparent that the described embodiments are only a part of the embodiments of the present disclosure and not all of the embodiments. Based on the embodiments in the present disclosure, all other embodiments obtained by a person of ordinary skill in the art without making inventive labor are within the scope of protection of the present disclosure.

The present disclosure provides a positively charged quaternary ammonium salt polymer catalyst, which is prepared by polymerization and anion exchange of a positively charged quaternary ammonium salt precursor.

In the catalyst provided by the invention, the positively charged quaternary ammonium salt precursor is a reaction product of an acrylate and a haloalkane, wherein, the acrylate is selected from the group consisting of dimethylaminoethyl acrylate, dimethylaminoethyl methacrylate, ethyl 3-(dimethylamino)acrylate and a mixture thereof, preferably dimethylaminoethyl methacrylate and/or dimethylaminoethyl acrylate; the haloalkane is selected from the group consisting of bromoundecane, bromododecane, bromotetradecane, bromohexadecane, bromoeicosane, chlorododecane, chlorotetradecane, chlorohexadecane, and a mixture thereof, preferably selected from the group consisting of bromoundecane, bromododecane, bromotetradecane, bromohexadecane, and a mixture thereof. When carrying out the reaction, preferably the molar ratio of the acrylate to the haloalkane is 1:(1-10), specifically 1:1, 1:1.1, 1:1.2, 1:1.3, 1:1.4, 1:1.5, 1:1.6, 1:1.7, 1:1.8, 1:1.9, 1:2, 1:2.5, 1:3, 1:3.5, 1:4, 1:4.5, 1:5, 1:6, 1:7, 1:8, 1:9 or 1:10; preferably, the reaction is performed at a temperature of 10-200° C.; the time of the reaction is 1-48 h.

In the catalyst provided by the present disclosure, preferably, the polymerization mode is cross-linking polymerization or addition polymerization; preferably, the cross-linking polymerization mode is photo-initiated cross-linking polymerization or thermally initiated cross-linking polymerization.

In the catalyst provided by the present disclosure, the purpose of the anion exchange is to remove the halogen counterions in the polymer, to avoid secondary pollution to the water body caused by the halogen counterions generating halogen free radicals and further generating toxic halogenated by-products in the process of water treatment. In the present disclosure, complete exchange of anions in the polymer is preferred; preferably the anion exchange is achieved by using an ion-exchange resin.

The present disclosure also provides a method of preparing the positively charged quaternary ammonium salt polymer catalyst mentioned in the above embodiments, comprising steps of:
a) reacting the acrylate with the haloalkane in a solvent to obtain the positively charged quaternary ammonium salt precursor;
b) performing polymerization of the positively charged quaternary ammonium salt precursor to obtain a polymer; and
c) performing ion exchange of anions in the polymer to obtain the positively charged quaternary ammonium salt polymer catalyst.

In the preparation method provided by the present disclosure, in step a), the type selection and amount ratio of the acrylate and the haloalkane have been described in the foregoing, and will not be repeated here; the solvent includes but is not limited to one or more of acetone, acetonitrile and tetrahydrofuran.

In the preparation method provided by the present disclosure, in step a), preferably the reaction is performed at a temperature of 10-200° C., specifically 10° C., 20° C., 30° C., 40° C., 50° C., 55° C., 60° C., 65° C., 70° C., 75° C., 80° C., 90° C., 100° C., 110° C., 120° C., 130° C., 140° C., 150° C., 160° C., 170° C., 180° C., 190° C. or 200° C.; preferably the time of the reaction is 1-48 h, specifically 1 h, 4 h, 8 h, 12 h, 16 h, 20 h, 24 h, 28 h, 32 h, 36 h, 40 h, 44 h or 48 h.

In the preparation method provided by the present disclosure, in step a), after the completion of reaction, the reaction mixture is cooled, and then a low-polarity solvent is added, at this time, white solid is precipitated from the solvent, filtered and dried, and the positively charged quaternary ammonium salt precursor is obtained.

In the preparation method provided by the present disclosure, in step b), preferably the polymerization mode is cross-linking polymerization or addition polymerization; preferably the cross-linking polymerization mode is photo-initiated cross-linking polymerization or thermally initiated cross-linking polymerization; wherein, when using photo-initiated cross-linking polymerization, the initiator used is photoinitiator; when using thermally initiated cross-linking polymerization, the initiator used is a thermal intiator; when using addition polymerization, the initiator used is a chain initiator for addition polymerization.

In the preparation method provided by the present disclosure, in step b), when the polymerization method adopted is photo-initiated cross-linking polymerization, the specific process comprises:
b1) mixing the positively charged quaternary ammonium salt precursor, water, an initiator (photoinitiator) and the cross-linking agent, and performing cross-linking polymerization under ultraviolet irradiation to obtain the polymer.

In the preparation method provided by the present disclosure, in step b1), preferably the mass ratio of the positively charged quaternary ammonium salt precursor to water is (0.1-20):1, specifically 0.1:1, 0.5:1, 1:1, 1.5:1, 1.6:1, 1.7:1, 2:1, 2.5:1, 2.7:1, 2.8:1, 3:1, 4:1, 5:1, 7:1, 10:1, 12:1, 15:1, 17:1 or 20:1.

In the preparation method provided by the present disclosure, in step b1), preferably, the initiator is selected from the group consisting of 2-hydroxy-2-methyl-1-propiophenone, 2-hydroxy-2-methyl-1-[4-(2-hydroxyethoxy)phenyl]-1-propanon, 2,2-dimethoxy-2-phenylacetophenone, and a mixture thereof; preferably, the cross-linking agent is selected from the group consisting of butyl acrylate, ethylene glycol dimethacrylate, 1,4-butanediol diacrylate, and a mixture thereof; preferably the mass ratio of the initiator to the cross-linking agent is 1:(0.5-2), specifically 1:0.5, 1:0.6, 1:0.7, 1:0.8, 1:0.9, 1:1, 1:1.1, 1:1.2, 1:1.3, 1:1.4, 1:1.5, 1:1.6, 1:1.7, 1:1.8, 1:1.9 or 1:2.

In the preparation method provided by the present disclosure, in step b1), preferably, the total mass of the initiator and the cross-linking agent accounts for 1-10 wt % of the total mass of the positively charged quaternary ammonium salt precursor and water, and specifically, it can be 1 wt %, 1.5 wt %, 2 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, 9 wt %, 9.5 wt % or 10 wt %.

In the preparation method provided by the present disclosure, in step b1), preferably, the wavelength of the ultraviolet irradiation is 200-400 nm, specifically 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 355 nm, 360 nm, 365 nm, 370 nm, 375 nm, 380 nm, 385 nm, 390 nm, 395 nm or 400 nm; preferably, the time of the cross-linking polymerization is 0.5-5 min, specifically 0.5 min, 1 min, 1.5 min, 2 min, 2.5 min, 3 min, 3.5 min, 4 min, 4.5 min or 5 min.

In the preparation method provided by the present disclosure, in step b), when the the polymerization method adopted is thermally initiated cross-linking polymerization, the specific process comprises:
b2) mixing the positively charged quaternary ammonium salt precursor, water, an initiator (thermal initiator) and the crosslinking agent in ethanol, heating to volatilize ethanol and carry out cross-linking polymerization of the mixture to obtain the polymer.

In the preparation method provided by the present disclosure, in step b2), preferably the mass ratio of the positively charged quaternary ammonium salt precursor to water is (0.1-20):1,specifically 0.1:1, 0.5:1, 1:1, 1.5:1, 1.6:1, 1.7:1, 2:1, 2.5:1, 2.7:1, 2.8:1, 3:1, 4:1, 5:1, 7:1, 10:1, 12:1, 15:1, 17:1 or 20:1.

In the preparation method provided by the present disclosure, in step b2), preferably the initiator is azobisisobutyronitrile and/or azobisisoheptanenitrile; the cross-linking agent is selected from the group consisting of butyl acrylate, ethylene glycol dimethacrylate, 1,4-butanediol diacrylate, and a mixture thereof; preferably the mass ratio of the initiator to the cross-linking agent is 1:(0.5-2), specifically 1:0.5, 1:0.6, 1:0.7, 1:0.8, 1:0.9, 1:1, 1:1.1, 1:1.2, 1:1.3, 1:1.4, 1:1.5, 1:1.6, 1:1.7, 1:1.8, 1:1.9 or 1:2.

In the preparation method provided by the present disclosure, in step b2), preferably, the total mass of the initiator and the cross-linking agent accounts for 1-10 wt % of the total mass of the positively charged quaternary ammonium salt precursor and water, and specifically, it can be 1 wt %, 1.5 wt %, 2 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, 9 wt %, 9.5 wt % or 10 wt %.

In the preparation method provided by the present disclosure, in step b2), preferably, the heating temperature is 40-90° C., specifically 40° C., 45° C., 50° C., 55° C., 60° C., 65° C., 70° C., 75° C., 80° C., 85° C. or 90° C.; preferably, the time of the cross-linking polymerization is 5-30 min, specifically 5 min, 7 min, 10 min, 12 min, 15 min, 17 min, 20 min, 23 min, 25 min, 27 min or 30 min.

In the preparation method provided by the present disclosure, in step b), when the polymerization method adopted is addition polymerization, the specific process comprises:
b3) mixing the positively charged quaternary ammonium salt precursor, an initiator (chain initiator for addition polymerization) and the catalyst in a solvent, heating for addition polymerization, and then dropping the obtained polymerization product solution into a low-polarity solvent to obtain the polymer.

In the preparation method provided by the present disclosure, in step b3), the initiator is a chain initiator for addition polymerization, preferably dimethylketene methyl trimethylsilyl acetal or 1-methoxy-1-tri(phenyl)silyl-2-methyl-1-propylene; preferably, the mass ratio of the positively charged quaternary ammonium salt precursor to the initiator is 1:(0.05-0.1), specifically 1:0.05, 1:0.06, 1:0.07, 1:0.08, 1:0.09 or 1:0.1.

In the preparation method provided by the present disclosure, in step b3), the catalyst is an organic alkali metal catalyst, preferably selected from the group consisting of diphenylmagnesium, phenylmagnesium bromide, phenylmagnesium chloride, and a mixture thereof; the mass ratio of the positively charged quaternary ammonium salt precursor to the catalyst is preferably 1:(0.005-0.02), specifically 1:0.005, 1:0.007, 1:0.01, 1:0.012, 1:0.015, 1:0.017 or 1:0.02.

In the preparation method provided by the present disclosure, in step b3), the solvent includes but is not limited to tetrahydrofuran.

In the preparation method provided by the present invention, in step b3), preferably, the heating temperature is 30-60° C., specifically 30° C., 35° C., 40° C., 45° C., 50° C., 55° C. or 60° C.; preferably, the time of the addition polymerization is 5-60 min, specifically 5 min, 10 min, 15 min, 20 min, 25 min, 30 min, 35 min, 40 min, 50 min or 60 min.

In the preparation method provided by the present disclosure, in step b3), the low-polarity solvent includes but is not limited to petroleum ether.

In the preparation method provided by the present disclosure, in step c), preferably, the specific process of carrying out the ion exchange comprises steps of:
mixing the polymer with an ion exchange solution for anion exchange, and removing the liquid phase to obtain the positively charged quaternary ammonium salt polymer catalyst.

In the specific process of ion exchange provided by the present disclosure, preferably, the ion exchange solution is sodium nitrate aqueous solution; preferably the concentration of the ion exchange solution is 0.01-1 mol/L, specifically 0.01 mol/L, 0.05 mol/L, 0.1 mol/L, 0.15 mol/L, 0.2 mol/L, 0.3 mol/L, 0.4 mol/L, 0.5 mol/L, 0.6 mol/L, 0.7 mol/L, 0.8 mol/L, 0.9 mol/L or 1 mol/L; preferably, the mixing time is 24-72 h, specifically 24 h, 28 h, 32 h, 36 h, 40 h, 44 h, 48 h, 52 h, 56 h, 60 h, 64 h, 68 h or 72 h.

The present disclosure also provides a method for treating organic pollutants in water, which comprises steps of:
activating a peroxide by using a positively charged quaternary ammonium salt polymer catalyst to degrade the organic pollutants in water;
wherein the positively charged quaternary ammonium salt polymer catalyst is the positively charged quaternary ammonium salt polymer catalyst described in the embodiments or the positively charged quaternary ammonium salt polymer catalyst prepared by the preparation method described in the embodiments.

In the water treatment method provided by the present disclosure, the organic pollutants in the water include but are not limited to one or more of 2,4-dichlorophenol, bisphenol A, sulfamethoxazole, phenol, acetaminophen and methylparaben; preferably, the concentration of the organic pollutants in the water is 10-100 μmol/L, specifically 10 μmol/L, 15 μmol/L, 20 μmol/L, 25 μmol/L, 30 μmol/L, 35 μmol/L, 40 μmol/L, 45 μmol/L, 50 μmol/L, 55 μmol/L, 60 μmol/L, 65 μmol/L, 70 μmol/L, 75 μmol/L, 80 μmol/L, 85 μmol/L, 90 μmol/L, 95 μmol/L or 100 μmol/L.

In the water treatment method provided by the present disclosure, preferably the water has a pH value of 4-12, specifically 4, 4.5, 5, 5.5, 6, 6.5, 7, 7.5, 8, 8.5, 9, 9.5, 10, 10.5, 11, 11.5 or 12.

In the water treatment method provided by the present disclosure, preferably the peroxide is selected from the group consisting of hydrogen peroxide, peracetic acid, sodium peroxydisulfate, potassium peroxydisulfate, ammonium peroxydisulfate, potassium peroxymonosulfate, sodium peroxymonosulfate, ammonium peroxymonosulfate, and a mixture thereof.

In the water treatment method provided by the present disclosure, preferably the amount ratio of the positively charged quaternary ammonium salt polymer catalyst to the peroxide is (0.05-20) g:(0.1-200) mmol, more preferably (0.05-1) g:(0.1-10) mmol, and most preferably (0.1-0.6) g:(0.5-2) mmol.

In the water treatment method provided by the present disclosure, preferably, the specific treatment process comprises:
A) adding the positively charged quaternary ammonium salt polymer catalyst and the peroxide into water, wherein the peroxide degrades organic pollutants in the water after being activated by the positively charged quaternary ammonium salt polymer catalyst; or
B) first adsorbing organic pollutants in the water by using the positively charged quaternary ammonium salt polymer catalyst, and then degrading adsorbed organic pollutants by using the peroxide after being activated by the positively charged quaternary ammonium salt polymer catalyst.

In the water treatment method provided by the present disclosure, the way of implementation of the step b) can be specifically as follows:
B1) first adding the positively charged quaternary ammonium salt polymer catalyst into water, and adsorbing organic pollutants in the water by using the positively charged quaternary ammonium salt polymer catalyst; then adding a peroxide into the water, wherein the peroxide degrades the adsorbed organic pollutants after being activated by the positively charged quaternary ammonium salt polymer catalyst; or
B2) passing the water through a packed column filled with the positively charged quaternary ammonium salt polymer catalyst, and adsorbing organic pollutants in the water by using the positively charged quaternary ammonium salt polymer catalyst in the packed column; then adding the peroxide into the packed column, wherein the peroxide degrades the adsorbed organic pollutants after being activated by the positively charged quaternary ammonium salt polymer catalyst.

In the water treatment method provided by the present disclosure, in step A) and step B1), preferably, the addition amount of the positively charged quaternary ammonium salt polymer catalyst in the water is 0.05-1 g/L, specifically 0.05 g/L, 0.1 g/L, 0.15 g/L, 0.2 g/L, 0.25 g/L, 0.3 g/L, 0.35 g/L, 0.4 g/L, 0.45 g/L, 0.5 g/L, 0.55 g/L, 0.6 g/L, 0.65 g/L, 0.7 g/L, 0.75 g/L, 0.8 g/L, 0.85 g/L, 0.9 g/L, 0.95 g/L or 1 g/L; the addition amount of the peroxide in the water is 0.1-50 mmol/L, specifically 0.1 mmol/L, 0.5 mmol/L, 1 mmol/L, 1.5 mmol/L, 2 mmol/L, 2.5 mmol/L, 3 mmol/L, 3.5 mmol/L, 4 mmol/L, 4.5 mmol/L, 5 mmol/L, 5.5 mmol/L, 6 mmol/L, 6.5 mmol/L, 7 mmol/L, 7.5 mmol/L, 8 mmol/L, 8.5 mmol/L, 9 mmol/L, 9.5 mmol/L, 10 mmol/L, 12 mmol/L, 15 mmol/L, 17 mmol/L, 20 mmol/L, 23 mmol/L, 25 mmol/L, 27 mmol/L, 30 mmol/L, 32 mmol/L, 35 mmol/L, 37 mmol/L, 40 mmol/L, 42 mmol/L, 45 mmol/L, 47 mmol/L or 50 mmol/L.

In the water treatment method provided by the present disclosure, in step B2), preferably, the addition amount of the positively charged quaternary ammonium salt polymer catalyst in the packed column is 1-50 mmol/L, specifically 1 mmol/L, 3 mmol/L, 5 mmol/L, 7 mmol/L, 10 mmol/L, 12 mmol/L, 15 mmol/L, 17 mmol/L, 20 mmol/L, 23 mmol/L, 25 mmol/L, 27 mmol/L, 30 mmol/L, 32 mmol/L, 35 mmol/L, 37 mmol/L, 40 mmol/L, 42 mmol/L, 45 mmol/L, 47 mmol/L or 50 mmol/L.

The embodiments provided by the present disclosure have at least the following advantages:
1) in the present disclosure, a functional polymeric catalyst containing a positively charged quaternary ammonium salt and a carbonyl functional group is chemically synthesized under simple and mild reaction conditions, the catalyst reacts with a peroxide to generate a ketone oxide intermediate, which further reacts with the peroxide to generate a singlet oxygen active species, which futher mineralizes and degrades the organic pollutant;
2) the catalyst provided by the present disclosure has good stability and antibacterial property, can efficiently and selectively catalyze peroxide to degrade organic pollutants, and has important practical significance for removing wastewater rich in organic pollutants, which is from agriculture, printing and dyeing industry, petrochemical industry and the like.
3) the catalyst provided by the present disclosure has s simple production method and low production cost, can realize large-scale industrial production and utilization, and has a wide application prospects in water pollution control and water environment restoration.

In order to be more clear, a detailed description will be given below through the following examples.

### EXAMPLE 1

50 g of bromotetradecane and 20 g of dimethylaminoethyl methacrylate were weighed and then dissolved in 100 mL of acetone solution, stirred for 30 min, then reacted at 70° C. for 48 h. After the completion of reaction, 150 mL of N-hexane was added, a large amount of white powder was precipitated, which was separated by suction funnel, and dried overnight at room temperature in vacuum, the positively charged quaternary ammonium salt precursor was obtained; 500 mg of the above-mentioned positively charged quaternary ammonium salt precursor was added into a 1.5 mL centrifuge tube, 180 mg of pure water was added, and was stirred for several times to mix evenly, and then, about 10 mg of 2,2-dimethoxy-2-phenylacetophenone as photoinitiator and 10 mg of ethylene glycol dimethacrylate as photocrosslinking agent were added, heated and mixed evenly again, taken out and laid on a glass slide, and cross-linking polymerization was carried out under ultraviolet light (365 nm) for 5 min at room temperature, then the cross-linked polymer was obtained. The above-mentioned cross-linked polymer was put into a mortar and ground into small particles, then were dispersed in sodium nitrate aqueous solution with a concentration of 1 M by ultrasonic dispersion, shook for 48 h, then filtered by suction, washed with distilled water and dried, and the positively charged quaternary ammonium salt polymer catalyst was obtained.

2 mM peroxymonosulfate (pollutant), 30 mg of the above-mentioned positively charged quaternary ammonium salt polymer catalyst and 10 μM 2,4-dichlorophenol were added into 50 ml of laboratory water with pH value of 12, stirring was maintained throughout the water treatment process, and 100% removal of pollutants was completed within 1 min.

### EXAMPLE 2

10 g of bromoundecane and 6 g of dimethylaminoethyl acrylate were weighed and then dissolved in 100 mL of tetrahydrofuran solution, stirred for 30 min, then reacted at 50° C. for 40 h. After the completion of reaction, 100 mL of ethyl acetate was added, a large amount of white powder was precipitated, and dried overnight at room temperature in vacuum, the positively charged quaternary ammonium salt precursor was obtained; 200 mg of the above-mentioned positively charged quaternary ammonium salt precursor was added into a 1 mL centrifuge tube, 100 mg of pure water was added, and was stirred for several times to mix evenly, and then, about 8 mg of 2,2-dimethoxy-2-phenylacetophenone as photoinitiator and 6 mg of ethylene glycol dimethacrylate as photocrosslinking agent were added, heated and mixed evenly again, taken out and laid on a glass slide, and cross-linking polymerization was carried out under ultraviolet light (365 nm) for 2 min at room temperature, then the cross-linked polymer was obtained. The above-mentioned cross-linked polymer was put into a mortar and ground into small particles, then were dispersed in sodium nitrate aqueous solution with a concentration of 1 M by ultrasonic dispersion, shook for 48 h, then filtered by suction, washed with distilled water and dried, the positively charged quaternary ammonium salt polymer catalyst was obtained.

2 mM peroxymonosulfate, 30 mg of the above-mentioned positively charged quaternary ammonium salt polymer catalyst and 10 μM 2,4-dichlorophenol were added into 50 ml of laboratory water with pH value of 12, stirring was maintained throughout the water treatment process, and 100% removal of pollutants was completed within 4 min.

### EXAMPLE 3

10 g of bromotetradecane and 6 g of dimethylaminoethyl methacrylate were weighed and then dissolved in 150 mL of acetonitrile solution, stirred for 25 min, then reacted at 65° C. for 40 h. After the completion of reaction, 200 mL of petroleum ether was added, a large amount of white powder was precipitated, and dried overnight at room temperature in vacuum, the positively charged quaternary ammonium salt precursor was obtained; 100 mg of the above-mentioned positively charged quaternary ammonium salt precursor was added into a 1 mL centrifuge tube, 60 mg of pure water was added, and was stirred for several times to mix evenly, and then, about 5 mg of azobisisobutyronitrile as thermal initiator and 5 mg of ethylene glycol dimethacrylate as cross-linking agent were added, dissolved in ethanol, and heated for cross-linking polymerization for 30 min, then the cross-linked polymer was obtained. The above-mentioned cross-linked polymer was put into a mortar and ground into small particles, then were dispersed in sodium nitrate aqueous solution with a concentration of 1 M by ultrasonic dispersion, shook for 48 h, then filtered by suction, washed with distilled water and dried, the positively charged quaternary ammonium salt polymer catalyst was obtained.

2 mM peroxymonosulfate, 30 mg of the above-mentioned positively charged quaternary ammonium salt polymer catalyst and 10 μM 2,4-dichlorophenol were added into 50 ml of laboratory water with pH value of 12, stirring was maintained throughout the water treatment process, and 100% removal of pollutants was completed within 10 min.

### EXAMPLE 4

10 g of bromotetradecane and 6 g of dimethylaminoethyl methacrylate were weighed and then dissolved in 150 mL of acetonitrile solution, stirred for 25 min, then reacted at 65° C. for 40 h. After the completion of reaction, 200 mL of petroleum ether was added, a large amount of white powder was precipitated, and dried overnight at room temperature in vacuum, the positively charged quaternary ammonium salt precursor was obtained. 100 mg of the above-mentioned positively charged quaternary ammonium salt precursor was added into a 100 mL flask, 5 mg of 1-methoxy-1-tri(phenyl)silyl-2-methyl-1-propylene, 1 mg of phenylmagnesium chloride and 30 mL of tetrahydrofuran were added, and were stirred to mix evenly, and then, cross-linking polymerization was carried out at 40° C. for 40 min, then 5 mL of polymer product solution was taken out and dropped into 30 mL of petroleum ether, the polymer was collected and dried. The above-mentioned cross-linked polymer was put into a mortar and ground into small particles, then were dispersed in sodium nitrate aqueous solution with a concentration of 1 M by ultrasonic dispersion, shook for 48 h, then filtered by suction, washed with distilled water and dried, the positively charged quaternary ammonium salt polymer catalyst was obtained.

2 mM peroxymonosulfate, 30 mg of the above-mentioned positively charged quaternary ammonium salt polymer catalyst and 10 μM 2,4-dichlorophenol were added into 50 ml of laboratory water with pH value of 12, stirring was maintained throughout the water treatment process, and 80% removal of pollutants was completed within 10 min.

### EXAMPLE 5

10 g of bromotetradecane and 6 g of dimethylaminoethyl methacrylate were weighed and then dissolved in 150 mL of acetonitrile solution, stirred for 25 min, then reacted at 65° C. for 40 h. After the completion of reaction, 200 mL of petroleum ether was added, a large amount of white powder was precipitated, and dried overnight at room temperature in vacuum, the positively charged quaternary ammonium salt precursor was obtained. 100 mg of the above-mentioned positively charged quaternary ammonium salt precursor was added into a 1 mL centrifuge tube, 60 mg of pure water was added, and was stirred for several times to mix evenly, and then, about 5 mg of azobisisobutyronitrile as thermal initiator and 5 mg of ethylene glycol dimethacrylate as cross-linking agent were added, dissolved in ethanol, and heated at 65° C. for cross-linking polymerization for 30 min, then the cross-linked polymer was obtained. The above-mentioned cross-linked polymer was put into a mortar and ground into small particles, then were dispersed in sodium nitrate aqueous solution with a concentration of 1 M by ultrasonic dispersion, shook for 48 h, then filtered by suction, washed with distilled water and dried, and the positively charged quaternary ammonium salt polymer catalyst was obtained.

50 mL of actual water (pH 8.25, conductivity 178.5 μs/cm) was taken and added with 2 mM peroxymonosulfate, 30 mg of the above-mentioned positively charged quaternary ammonium salt polymer catalyst and 10 μM 2,4-dichlorophenol, stirring was maintained throughout the water treatment process, and 100% removal of pollutants was completed within 30 min.

### EXAMPLE 6

This example differs from Example 1 in that the organic pollutants in the degradation process were bisphenol A, sulfamethoxazole, phenol, acetaminophen or methylparaben, the other steps and parameters were the same. When the pH value was 7, the same concentration of bisphenol A, sulfamethoxazole, phenol, acetaminophen and methylparaben completed 100% removal within 10 min, 100% removal within 10 min, 80% removal within 15 min, 100% removal within 12 min, and 93% removal within 15 min, respectively.

### Performance Testing and Characterization

### (1) Structure and Characterization of Catalyst

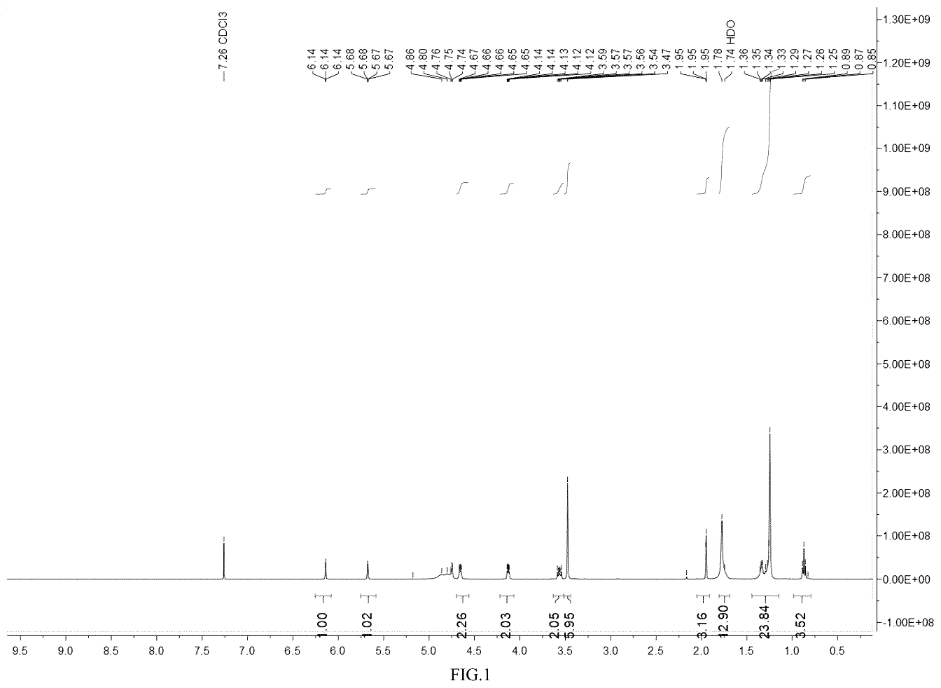

The positively charged quaternary ammonium salt precursor prepared in Example 1 was analyzed by nuclear magnetic resonance (NMR): the data of NMR hydrogen spectrum (FIG. 1) were obtained by using a Bruker AVANCE AV III 400 liquid NMR at the physicochemical experiment center of University of Science and Technology of China, with deuterated chloroform as solvent: δ(ppm) 6.16 (s, 1H), 5.12 (s, 1H), 4.63 (m, 2H), 4.12 (m, 2H), 3.55 (m, 2H), 3.44 (s, 6H), 1.94 (s, 3H), 1.76 (m, 12H), 1.23-1.36 (m, 23H), 0.88 (m, 3H).

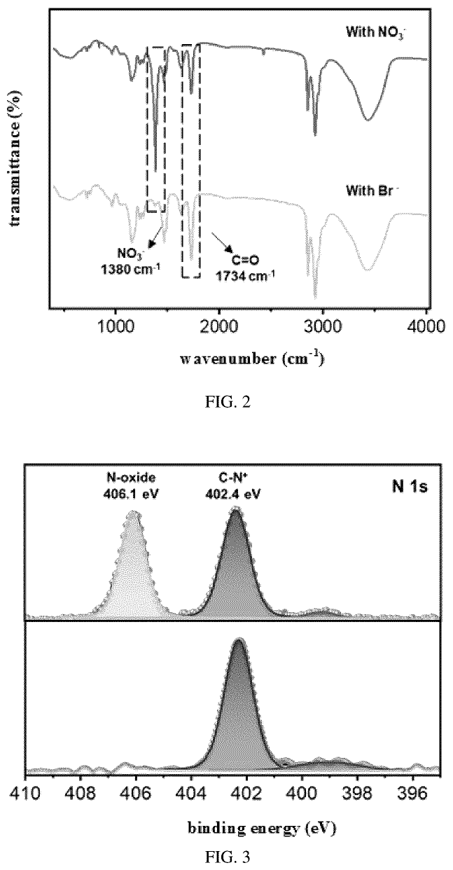

Infrared spectrum analysis was carried out on the positively charged quaternary ammonium salt polymer catalyst prepared in Example 1: completed on Thermo Scientific Nicolet 8700 in the physicochemical experiment center of University of Science and Technology of China, the scanning range is 4000-400 cm⁻¹, and the results are shown in FIG. 2. From FIG. 2, it can be seen that the vibration absorption peak appeared at 1380 cm⁻¹ after replacing Cl⁻ with NO₃⁻ ions.

The positively charged quaternary ammonium salt polymer catalyst prepared in Example 1 was analyzed by X-ray photoelectron spectroscopy, and the content of C, N and O elements in the catalyst was specifically analyzed. The catalyst was tested on ESCALAB 250Xi in the physicochemical experiment center of University of Science and Technology of China, and the results are shown in FIG. 3. The data in FIG. 3 shows that after ion exchange, the peak of N—O bond obviously appeared, and the ratio of N—O content to C—N content was 1:1, indicating that the Br as counterion had been completely replaced by NO₃⁻.

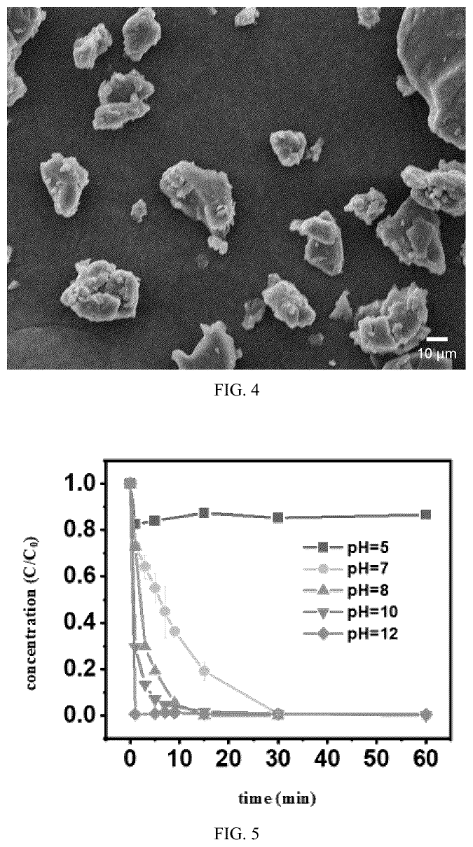

The surface of the positively charged quaternary ammonium salt polymer catalyst prepared in Example 1 was analyzed by scanning electron microscopy: it was characterized by GeminiSEM 450 field emission scanning electron microscope in the physicochemical experiment center of University of Science and Technology of China (FIG. 4), when the magnification reached 1000 times, it was found that the surface of the ground catalyst powder was flat and had a few wrinkles.

(2) Test and Analysis of Organic Pollutant 2,4-dichlorophenol Degraded by Catalyst

At room temperature, 50 mL of phosphate buffer solutions with different pH values were prepared, and 20 mg of the positively charged quaternary ammonium salt polymer catalyst prepared in Example 1 and organic pollutant 2,4-dichlorophenol (10 μM) were added with stirring for 30 min to ensure the adsorption equilibrium, then PMS (1 mM) was added, and the supernatant was filtered every 1 min and tested by high performance liquid chromatography, and then the degradation rate of pollutants was calculated according to the test results. The results are shown in FIG. 5. As can be seen from FIG. 5, under the alkaline condition of pH=12, the catalyst firstly absorbed a large amount of pollutants (about 98%) and then began to degrade the pollutants, and the degradation was completed within two minutes.

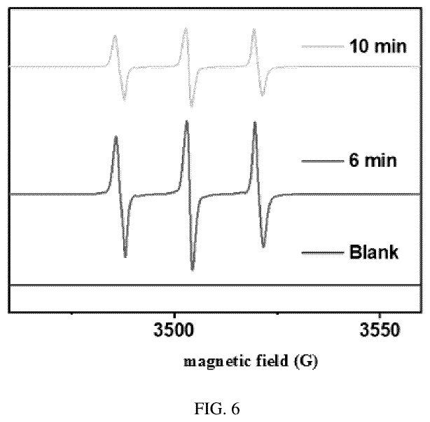

It was found by electron paramagnetic resonance spectroscopy (EPR) testing that the positively charged quaternary ammonium salt polymer catalyst prepared in Example 1 activated PMS and finally generated singlet oxygen (FIG. 6). As the reaction progressed, the singlet oxygen content was gradually consumed by pollution decomposition.

The above are only preferred embodiments of the present disclosure, and it should be noted that for those of ordinary skill in the art, several improvements and modifications can also be made without departing from the principle of the present disclosure, and these improvements and modifications should also be considered as the protection scope of the present disclosure.

1. A positively charged quaternary ammonium salt polymer catalyst, which is prepared from a positively charged quaternary ammonium salt precursor by polymerization and anion exchange, the positively charged quaternary ammonium salt precursor is a reaction product of an acrylate and a haloalkane;
wherein the acrylate is selected from the group consisting of dimethylaminoethyl acrylate, dimethylaminoethyl methacrylate, ethyl 3-(dimethylamino)acrylate and a mixture thereof; and
the haloalkane is selected from the group consisting of bromoundecane, bromododecane, bromotetradecane, bromohexadecane, bromoeicosane, chlorododecane, chlorotetradecane, chlorohexadecane, and a mixture thereof.

2. The positively charged quaternary ammonium salt polymer catalyst according to claim 1, wherein the acrylate is dimethylaminoethyl acrylate and/or dimethylaminoethyl methacrylate; and the haloalkane is selected from the group consisting of bromoundecane, bromododecane, bromotetradecane, bromohexadecane and a mixture thereof.

3. A method of preparing the positively charged quaternary ammonium salt polymer catalyst according to claim 1, comprising steps of:
a) reacting the acrylate with the haloalkane in a solvent to obtain the positively charged quaternary ammonium salt precursor;
b) performing polymerization of the positively charged quaternary ammonium salt precursor to obtain a polymer; and
c) performing ion exchange of anions in the polymer to obtain the positively charged quaternary ammonium salt polymer catalyst.

4. The preparation method according to claim 3, wherein, in step a), the reaction is performed at a temperature of 10-200° C.; and the time of the reaction is 1-48 h.

5. The preparation method according to claim 3, wherein, the step b) specifically comprising steps of:
b1) mixing the positively charged quaternary ammonium salt precursor, water, an initiator and a cross-linking agent, and performing cross-linking polymerization under ultraviolet irradiation to obtain the polymer, wherein the initiator is a photoinitiator; or
b2) mixing the positively charged quaternary ammonium salt precursor, water, an initiator and a cross-linking agent in ethanol, heating to volatilize ethanol and performing cross-linking polymerization of the mixture to obtain the polymer, wherein the initiator is a thermal initiator; or
b3) mixing the positively charged quaternary ammonium salt precursor, an initiator and a catalyst in a solvent, heating for addition polymerization, and then dropping the obtained polymerization product solution into a low-polarity solvent to obtain the polymer, wherein the initiator is an chain initiator for addition polymerization, and the catalyst is an organic alkali metal catalyst.

6. The preparation method according to claim 5, wherein,
in step b1), the mass ratio of the positively charged quaternary ammonium salt precursor to water is (0.1-20):1; the mass ratio of the initiator to the cross-linking agent is 1:(0.5-2); the total mass of the initiator and the cross-linking agent accounts for 1-10 wt % of the total mass of the positively charged quaternary ammonium salt precursor and water; the time of cross-linking polymerization is 0.5-5 min;
in step b2), the mass ratio of the positively charged quaternary ammonium salt precursor to water is (0.1-20):1; the mass ratio of the initiator to the cross-linking agent is 1:(0.5-2); the total mass of the initiator and the cross-linking agent accounts for 1-10 wt % of the total mass of the positively charged quaternary ammonium salt precursor and water; the heating is performed at a temperature of 40-90° C.; and the time of cross-linking polymerization is 5-30 min;
in step b3), the mass ratio of the positively charged quaternary ammonium salt precursor, initiator and catalyst is 1:(0.05-0.1):(0.005-0.02); the heating temperature is 30-60° C.; the time of addition polymerization is 5-60 min.

7. A method for treating organic pollutants in water, comprising steps of:
activating a peroxide by using a positively charged quaternary ammonium salt polymer catalyst to degrade organic pollutants in water;
wherein the positively charged quaternary ammonium salt polymer catalyst is the positively charged quaternary ammonium salt polymer catalyst according to claim 1.

8. The preparation method according to claim 7, wherein the treatment specifically comprises:
A) adding the positively charged quaternary ammonium salt polymer catalyst and a peroxide into water, wherein the peroxide degrades organic pollutants in the water after being activated by the positively charged quaternary ammonium salt polymer catalyst; or
B) firstly adsorbing organic pollutants in water by using the positively charged quaternary ammonium salt polymer catalyst, and then degrading adsorbed organic pollutants by using the peroxide after being activated by the positively charged quaternary ammonium salt polymer catalyst.

9. The method according to claim 7, wherein the amount ratio of the positively charged quaternary ammonium salt polymer catalyst and the peroxide used is (0.05-20) g:(0.1-200) mmol.

10. The method according to claim 7, wherein the water has a pH value of 4-12.
